(19) United States
(12) Patent Application Publication
(10) Pub. No.: US 2011/0104397 A1
(43) Pub. Date: May 5, 2011

(54) METHOD OF MANUFACTURING CEILING FAN BLADES

(76) Inventors: HSIEN-CHIN LIAO, Taichung City (TW); Ku-Hua Lin, Lu-Chou City (TW)

(21) Appl. No.: 13/004,846

(22) Filed: Jan. 11, 2011

Related U.S. Application Data
(63) Continuation-in-part of application No. 11/934,061, filed on Nov. 1, 2007.

(51) Int. Cl. B05D 3/06

(52) U.S. Cl. 427/557

(57) ABSTRACT

A method of manufacturing a ceiling fan blade which includes the steps of printing a patterned layer on a surface of the ceiling fan blade, applying infrared ray to heat the patterned layer at 100-150 degrees centigrade for 1-3 minutes, and spraying a shining layer on a surface of the patterned layer, the shining layer being made of a powder coating material mixed with a thermosetting powder coating material, the power coating material being selected from a group consisting of tertiary amine or imidazole and its derivatives, the thermosetting powder coating material being selected from a group consisting of hydroxyl group polyester resin, carboxylic group polyester resin, acid anhydride, phenol resin, aromatic amine or aliphatic amine, whereby the method is simplified in working procedures can be and environmentally friendly.

### CROSS-REFERENCE

This is a continuation-in-part of the co-pending patent application Ser. No. 11/934,061.

### BACKGROUND OF THE INVENTION

1. Field of the Invention

The present invention relates to a method of manufacturing ceiling fan blades, and more particularly to one which is low in cost and environmentally friendly.

2. Description of the Prior Art

Referring to FIGS. 1-2, one side A of a conventional fan blade 10 comprises a patterned paper layer 11, three adhesive paint layers 12 and a shining paint layer 13. The patterned paper layer 11 is attached to a surface A of the fan blade 10. The three 10 adhesive paint layers 12 are formed on a surface of the patterned paper layer 11 by spraying. The shining paint layer 13 is formed on the surface of the three adhesive paint layers 12 by spraying.

Since the blade 10 is made of wood, the surface A of the blade 10 must be rubbed flat at the time of attaching the patterned paper layer 11. Additionally, since 15 the shining paint layer 13 is difficult to be attached to the patterned paper layer 11, the patterned paper layer 11 must be sprayed with three-adhesive paint layers 12, so that the shining paint layer can be attached to the surface of the three adhesive paint layers 12. The cost must be increased due to the fussy working procedures.

Furthermore, the three adhesive paint layers 12 and the shining paint layer 13 must be used with the solvent. However, since there is lead in the solvent, the environment will be polluted and the solvent itself will cause the damage to the human being.

In addition, the patterned paper layer 11 is attached on the surface A of the blade 10. Even though the patterned paper layer 11 is sprayed with an adhesive paint layer 12 and the shining-paint layer 13, it still can be disrupted due to scraping, leading to an unbeautiful appearance. After the blade 10 is attached to the patterned paper layer 11, unfortunately the primary color of the wood material will lose.

Additionally the side surface B of the blade 10 has a quite small area, and the side surface B is unlikely to be attached to the patterned paper layer 11, thus causing the side surface B not so beautiful.

Biller et al (U.S. Pat. No. 5,789,039) discloses powder coatings curable by exposure to radiation, typically ultraviolet radiation. However, ultraviolet curable coating is expensive and has to be melted by infrared ray and then fixed by ultraviolet ray thereby increasing the manufacturing cost. Furthermore, ultraviolet curable coating cannot be fixed unless subject to direct ultraviolet ray and so it will be impossible for the ultraviolet curable coatings in recessed portion to be fixed. Moreover, the ultraviolet curable coatings are slightly transparent thus causing a destruction of beauty.

Therefore, it is object of the present invention to provide an improved method of manufacturing ceiling fan blades which can obviate and mitigate the above-mentioned drawbacks.

### SUMMARY OF THE INVENTION

This invention is related to a method of manufacturing a ceiling fan blade which includes the steps of printing a patterned layer on a surface of the ceiling fan blade, applying infrared ray to heat the patterned layer at 100-150 degrees centigrade for 1-3 minutes, and spraying a shining layer on a surface of the patterned layer, the shining layer being made of a powder coating material mixed with a thermosetting powder coating material, the power coating material being selected from a group consisting of tertiary amine or imidazole and its derivatives, the thermosetting powder coating material being selected from a group consisting of hydroxyl group polyester resin, carboxylic group polyester resin, acid anhydride, phenol resin, aromatic amine or aliphatic amine.

The primary object of the present invention is to provide a method of manufacturing a ceiling fan blade which is simplified in the working procedures.

The second object of the present invention is to provide a method of manufacturing a ceiling fan blade which is environmentally friendly.

The foregoing objects and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a conventional ceiling fan blade;

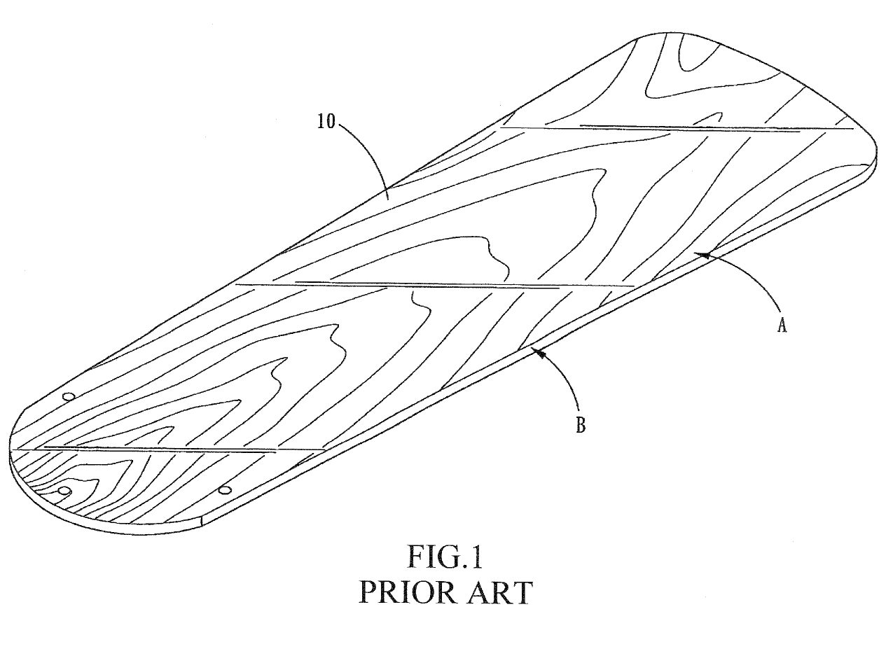

FIG. 2 is a partial cross sectional view of the conventional ceiling fan blade;

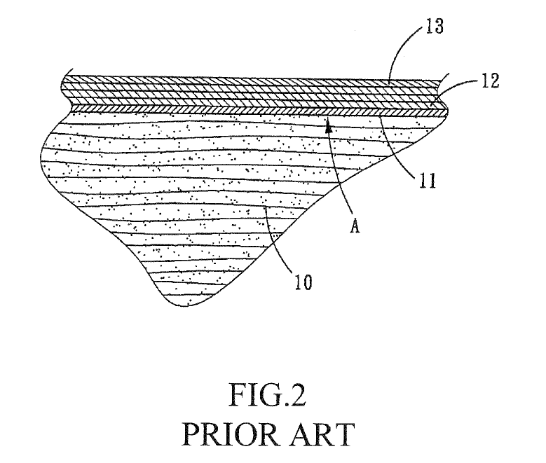

FIG. 3 is a perspective view showing a ceiling fan blade in accordance with the present invention installed on the ceiling fan;

FIG. 4 is a perspective view of the ceiling fan blade in accordance with the present invention; and

FIG. 5 is a partial cross sectional view of the ceiling fan blade in accordance with the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

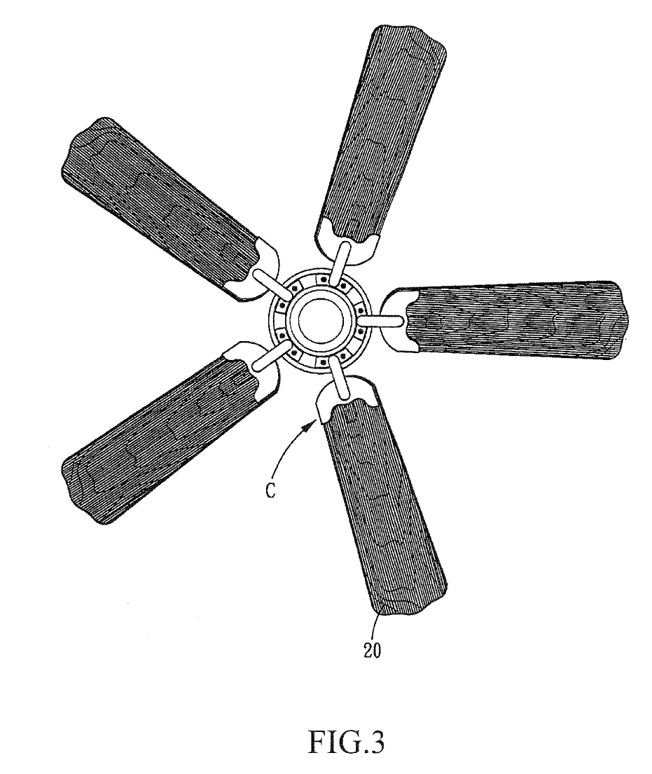

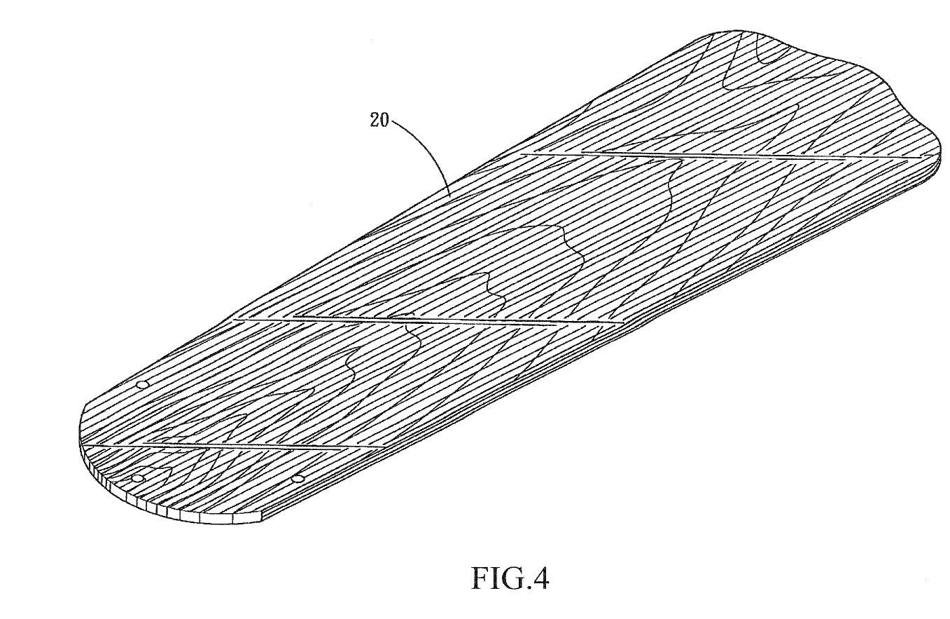

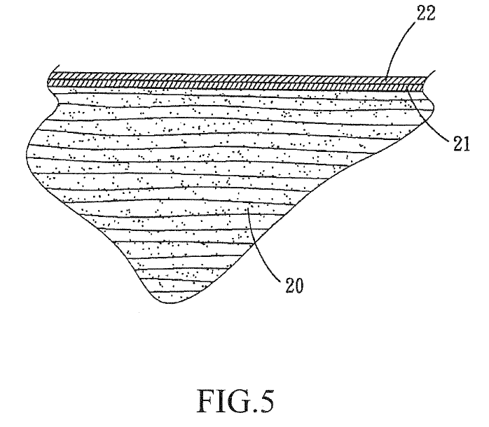

Referring to FIGS. 4-5, a ceiling fan blade 20 which is installed on the ceiling fan C (as shown hi FIG. 3) in accordance with a preferred embodiment of the present invention is made of wood. The manufacturing process of the ceiling fan blade 20 comprises the following step:

1. printing a patterned layer 21 on the surface of the ceiling fan blade 20;

2. applying infrared ray to heat the patterned layer 21 at 100-150 degrees centigrade for 1-3 minutes; and

3. spraying a shining layer 22 on the surface of the patterned layer 21, the shining layer 22 being made of a powder coating material mixed with a thermosetting powder coating material, the power coating material being selected from the group consisting of tertiary amine or imidazole and its derivatives, the thermosetting powder coating material being selected from the group consisting of hydroxyl group polyester resin, carboxylic group polyester resin, acid anhydride, phenol resin, aromatic amine or aliphatic amine.

As known from the above, the blade 20 is only required to be printed with the patterned layer 21 and finished by thermally fixing the shining layer 22. However, the surface A of the conventional blade 10 is attached with patterned paper layer 11, and then sequentially sprayed with the three adhesive paint layers 12 and the shining paint layer 13. As known from the comparison, the shining layer 22 of the present invention is thermally fixed on the surface of the blade 20 after being sprayed. However, the conventional shining paint layer 13 is attached after the three adhesive paint layers 12 being sprayed, so that it can enhance the adhesive force. Thus, it is obvious that the working procedures in accordance with the present invention are more simplified and fast.

Furthermore, the shining layer 22 is thermally fixed on the surface of the blade 20 after being sprayed. However, the three adhesive paint layers 12 and the shining paint layer 13 of the conventional blade 10 must use the solvent which will cause the pollution in the environment. In addition, the thermosetting powder coating used in the shining layer 22 of the present invention is still in powder state before being heated, so the surplus powder can be recycled, while the paint and the solvent used on the conventional blade 10 cannot be recycled. Therefore, the ceiling fan blade of the present invention is more environment-friendly than the conventional blade.

In addition, the patterned layer 21 of the present invention is directly printed on the surface of the blade 20, so it won't be broken like the patterned paper layer 11. Hence, the blade of the present invention is more durable and beautiful.

Additionally, the conventional blade 10 is attached on the surface thereof with the patterned paper layer 11, and the side surface B of the blade 10 is unlikely to be attached to the patterned paper layer 11 due to its excessively small area, thus affecting the appearance of the blade 10 because of the sharp contrast between the two sides. The overall blade 20 of the present invention has the primary color of the wood, and further the blade 20 is printed on the surface thereof with the patterned layer 21, so that the appearance of the blade 20 is more natural and beautiful.

To summarize, the ceiling fan blade of the present invention is improved. The blade of the present invention sequentially comprises a patterned layer and a shining layer on the surface thereof. By comparing with the conventional blade which comprises a patterned paper layer, three adhesive paint layers and a shining paint layer, the present invention only comprises the patterned layer and the shining layer, so the present invention is much simpler in the fabrication. Additionally the three adhesive paint layers and the shining layer of the conventional blade must use the solvent which will pollute the environment while the shining layer of the present invention uses the thermosetting powder coating to be thermally fixed on the blade without using any solvent which will pollute the environment, so the present invention, is more environment-friendly.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method of manufacturing a ceiling fan blade:
a. printing a patterned layer on a surface of said ceiling fan blade;
b. applying infrared ray to heat said patterned layer at 100-150 degrees centigrade for 1-3 minutes; and
c. spraying a shining layer on a surface of said patterned layer, said shining layer being made of a powder coating material mixed with a thermosetting powder coating material, said power coating material being selected from a group consisting of tertiary amine or imidazole and its derivatives, said thermosetting powder coating material being selected from a group consisting of hydroxyl group polyester resin, carboxylic group polyester resin, acid anhydride, phenol resin, aromatic amine or aliphatic amine.
